(19) United States
(12) Patent Application Publication
(10) Pub. No.: US 2006/0221407 A1
(43) Pub. Date: Oct. 5, 2006

(54) Image reading method and system

(75) Inventors: Hisashi Uchida, Kuze-gun (JP); Yoshiyuki Tamai, Itami-shi (JP); Masami Yamada, Osaka (JP); Hiroyuki Kawabata, Kawanishi-shi (JP)

Correspondence Address: MORRISON & FOERSTER LLP, 1650 TYSONS BOULEVARD, SUITE 300, MCLEAN, VA, 22102, US

(73) Assignee: Konica Minolta Business Technologies, Inc., Tokyo (JP)

(21) Appl. No.: 11/206,122

(22) Filed: Aug. 18, 2005

(30) Foreign Application Priority Data
Mar. 31, 2005 (JP) 2005-101976

(51) Int. Cl. H04N 1/40

(52) U.S. Cl. 358/448; 358/474

(57) ABSTRACT

There is provided an image reading method and an image reading system enabling various settings with easy operation and capable of acquiring image data obtained through scanning in a state where the client's security is fully secured. An image reading apparatus and an information processing apparatus connected with the image reading apparatus over a network are provided, and a shared storage area readable/writable by the image reading apparatus and the information processing apparatus is provided in the image reading apparatus or in an electric computer or in another apparatus connected with the network. The information processing apparatus creates an image link object associated with information relating to scanning and transmits scan preparation information including information relating to the scanning to the image reading apparatus. The image reading apparatus executes scanning based on the scan preparation information received, and saves an image data file obtained through scanning on the shared storage area.

This application is based on an application No. 2005-101976 filed in Japan, the contents of which are hereby incorporated by reference.

### BACKGROUND OF THE INVENTION

1. Field of the Invention

The present invention relates to a method and a system for scanning original image by using an image reading apparatus and an information processing apparatus connected with each other over a network.

2. Description of the Related Art

There is known a system for reading an original in which an image reading apparatus (e.g. scanner) or an image processing apparatus having a function of converting information recorded on a media such as paper (original information) to image data capable of being processed by an electronic computer, that is, a scanning function, is connected with a network using a communication line or the like, and the image reading apparatus is operated by an operator from an electronic computer such as a personal computer connected with the network, and the scanner executes scanning and the operator acquires the obtained image data over the network. In such a system, the electronic computer operated by the operator is called a client, and a device which actually instructs a scanning function to the image reading apparatus in accordance with an instruction input by the operator and manages the saving destination of the image data obtained through the scanning is called a scanner server. The client and the scanner server may not be separate devices, and the client may have the server function therein.

The above-mentioned network includes the Internet, a network using virtual private network (VPN) etc., and local area network (LAN).

Further, there is a system in which scanning is performed in a configuration where an electronic computer operated by an operator and an image reading apparatus are connected one to one.

In any system configuration described above, an operator must input, to the scanner or the client before scanning is executed, so-called information about scanner settings and about storage destination of image data, such as the size of the original to be scanned, scanning resolution, color scanning or monochrome scanning, saving destination of image data obtained through scanning, file format of the image data, and a file name etc. This input may sometime be a very troublesome work for the operator.

Therefore, there have been developed a method and a system enabling an operator of the client to input scanner settings and the like easily and enabling to acquire image data obtained through scanning easily.

Japanese Patent Application Laid-open No. 2001-028655 provides a system in which the operator can set an address in a scanner using a client. In the system disclosed in the Japanese Patent Application Laid-open No. 2001-028655, the address set in a scanner can be set without using a server. This improves operability of the operator in changing and registering the address of the data transmission destination.

Japanese Patent Application Laid-open No. 06-004642 provides an image data management system wherein operations for inputting image data and managing it as personal data and outputting it are simplified. In the system disclosed in the Japanese Patent Application Laid-open No. 06-004642, image data (or its pointer) is recorded on a storage medium provided in the network in accordance with information stored on a portable storage medium, and the data can be read out from the storage medium and printed easily. This system contributes to promote paperless environment in offices.

Japanese Patent Application Laid-open No. 2003-244377 provides a scanner server wherein setting of a scanner and data format of image data can be performed easily. The scanner server according to the Japanese Patent Application Laid-open No. 2003-244377 displays a virtual file on the client, the file name of which includes settings of the scanner and a data format of the image data to be obtained, etc., and when the operator selects a virtual file having desired scanner setting etc., the scanner scans the image data under the settings indicated as the file name of the virtual file, and the image data obtained through the scanning is stored in the virtual file selected by the operator. Thereby, the operations for the scanning become easier.

However, when setting the settings of the scanner and/or settings of the storage destination of image data obtained through the scanning, these setting operations are still troublesome, and these operations are to be performed on the scanner or the client. Further, there is a case where a dedicated application program is required for these setting operations.

Further, in order to save image data obtained through the scanning in the client, at least a part of the storage area of the client is required to be in a readable/writable state to the network. Hence this requirement causes a security problem. The present invention has been developed in view of the above-described problems.

### SUMMARY OF THE INVENTION

In view of the foregoing, it is an object of the present invention to provide an image reading method and an image reading system, which enable an operator to perform various settings about the system with easy operations.

And it is a still further object of the present invention to provide an image reading method and an image reading system, by which an operator can acquire image data obtained through a scanning with an operator's client machine fully secured.

A first aspect of the present invention is an image reading system including: an image reading apparatus which scans an original optically and converting the original to image data; an information processing apparatus connected with the image reading apparatus over a network; and a storage device having a shared storage area which is shared by the image reading apparatus and the information processing apparatus, the storage device is provided in the image reading apparatus or in the information processing apparatus or in another apparatus connected with the network, wherein the information processing apparatus includes: an image link object creator which creates an image link object, where the image link object is associated with scanner setting information and storage destination information, where the scanner setting information is setting information relating to scanning of the image reading apparatus and the storage destination information is information about a storage destination of an image data file created by the scanning of the image reading apparatus; and a transmitter which transmits scan preparation information to the image reading apparatus, where the scan preparation information includes the scanner setting information and the storage destination information, and the image reading apparatus includes: a receiver which receives the scan preparation information transmitted from the information processing apparatus; a scan executor which executes the scanning based on the scanner setting information; and an image data saver which saves image data created through the scanning onto the storage destination of the image data file based on the storage destination information.

A second aspect of the present invention is an image reading method including the steps of: creating an image link object on an information processing apparatus, where the image link object is associated with scanner setting information which is setting information relating to scanning of an image reading apparatus and with storage destination information which is information about a storage destination of image data created through the scanning by the image reading apparatus; transmitting scan preparation information to the image reading apparatus from the information processing apparatus, where the scan preparation information includes the scanner setting information and the storage destination information associated with the image link object; receiving the scan preparation information in the image reading apparatus; executing the scanning based on the scanner setting information in the image reading apparatus; and saving an image data file created in the scan executing step on the storage destination of the image data file based on the storage destination information.

A third aspect of the present invention is A program, executable by an information processing apparatus, for prompting an image reading apparatus to execute scanning under a prescribed condition and to save an obtained image data file on a prescribed storage area, the program including the steps of: creating an image link object which is associated with scanner setting information and storage destination information, where the scanner setting information is setting information relating to scanning of the image reading apparatus and the storage destination information is information about a storage destination of an image data file created by the scanning of the image reading apparatus; and transmitting scan preparation information to the image reading apparatus, where the scan preparation information includes the scanner setting information and the storage destination information associated with the image link object.

A forth aspect of the present invention is a program, executable by an image reading apparatus, for performing scanning based on scan preparation information including scanner setting information which is setting information relating to scanning of the image reading apparatus and storage destination information which is information about a storage destination of an image data file created through scanning by the image reading apparatus, the program including the steps of: receiving the scan preparation information transmitted by an information processing apparatus; executing scanning based on the scanner setting information; and saving an image data file obtained through scanning on the storage destination of the image data file based on the storage destination information.

One of advantages of the present invention is that image data, suitable for processing in an information processing apparatus, can be obtained easily and safely by an image reading apparatus such as a scanner with a simple operation.

### BRIEF DESCRIPTION OF THE DRAWINGS

The above and further objects and novel features of the invention will more fully appear from the following detailed description when the same is read in connection with the accompanying drawings, and in which:

FIG. 1 is a schematic diagram of a configuration of a system according to the present invention;

FIG. 2 is a block diagram of multifunction peripherals (MFP);

FIG. 3 is a block diagram of a client personal computer (PC);

FIG. 4 is a flowchart of an executable process according to a method of the present invention;

FIGS. 5A, 5B, 5C, 5D, 5E, 5F, 5G, 5H, 5I, and 5J are schematic diagrams of exemplary displays of the system according to the present invention; and

FIGS. 6, 7, 8, 9, 10, 11, and 12 are flowcharts of executable processes according to the method of the present invention.

It is to be expressly understood, however, that the drawings are for the purpose of illustration only and are not intended as definitions of the limits of the invention.

### DETAILED DESCRIPTION OF THE PREFERRED EMBODIMENTS

Preferred embodiments of the present invention are described in more detail below referring to the accompanying drawings.

(System Configuration)

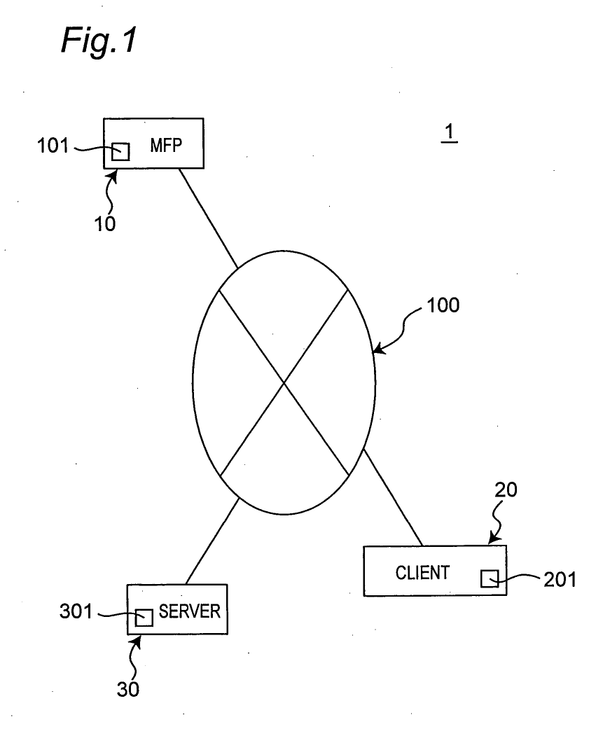

FIG. 1 is a schematic diagram showing a system according to an embodiment of the present invention.

The present system includes a digital complex machine (hereinafter referred to as multifunction peripherals (MFP)) 10 having a scanning function. The MFP 10 is connected with a client personal computer (PC) 20 which is an information processing apparatus and a server 30 over a network 100. Although the present system is configured to include one MFP 10 in FIG. 1, a plurality of MFPs may be included in the system.

The client PC 20 may be an electronic computer, and also be a personal computer having an interface capable of connecting with the network 100.

The scanner server 30 is a server which enables the scanning function of the MFP 10 to be used within the network 100. The scanner server 30 may be composed of a personal computer having a specification required to realize the scanner server function and an application program for realizing the scanner server function. Note that the scanner server function provided by the scanner server 30 may be realized in the client PC 20. In such a case, the scanner server 30 is not required to exist within the network 100 independent from the client PC 20.

Referring to FIG. 1, the present system is configured to include one client PC 20 and one scanner server 30. However, both of them may be provided in plural numbers, respectively. In such a case, the client PC 20 explained in the following description of the present system means a personal computer used by an operator.

The network 100 may be a network using a public circuit such as the Internet, or a network using a privately used circuit such as a LAN. Further, the network 100 may be a LAN connected with the Internet. Further, the network 100 includes a topology (connection mode) using a means for point-to-point connection (e.g., a USB cable) for connecting the client PC 20 also having the scanner server function and the MFP 10.

The MFP 10 is capable of providing, inside its body, a so-called shared folder (Box) 101, that is, a shared storage area, which can be shared over the network 100. The Box means a storage area being at least a part of the storage of the MFP 10 and is readable/writable over the network 100. For example, The Box is divided into a plurality of partitions, each of which is a storage area where only a registered user can use privately. Further, the client PC 20 and the scanner server 30 are also capable of providing shared storage areas, or so-called shared folders 201 and 301, which can be shared over the network 100. In the present system, there is required at least one of the shared folder (Box) 101 and the shared folders 201 and 301 in the whole system. For example, if the shared folder 301 is provided in the scanner server 30, there is no need to provide the shared folder 201 in the client PC 20, which is readable/writable over the network 100. It is advantageous to improve the security of the client PC 20 to provide at least one of the shared folder (Box) 101 and the shared folder 301 either in the MFP 10 or in the scanner server 30.

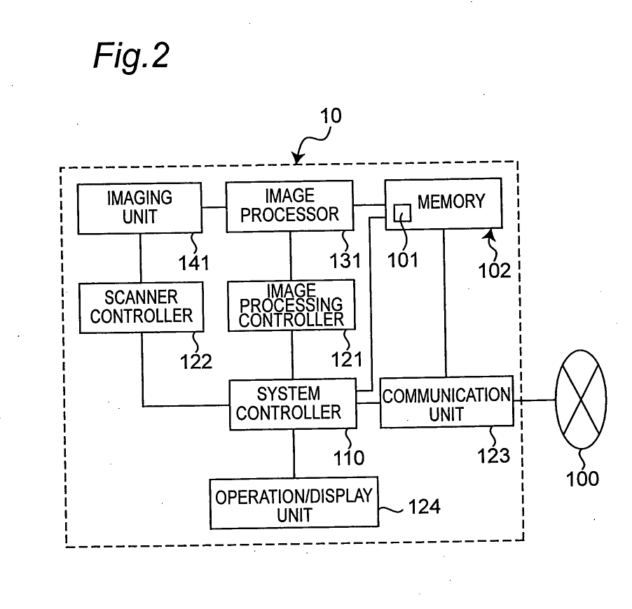

Next, the configuration of the MFP 10 will be described with reference to FIG. 2. The MFP 10 used in the present system is connected with the network 100 via a communication unit 123. The communication unit 123 is controlled by a system controller 110, and is also connected with a memory 102 also controlled by the system controller 110. The memory 102 has the shared folder (Box) 101. Further, the system controller 110 is connected so as to be able to control an image processing controller 121 and a scanner controller 122. The scanner controller 122 controls an imaging unit 141 which optically scans an original placed. The image processing controller 121 controls the image processor 131 which processes optical image information having been processed electrically and being inputted from the imaging unit 141. The image processor 131 is connected with the memory 102 so as to be able to perform inputting and outputting of information with the memory 102.

When operating the MFP 10 itself, an operator operates an operation/display unit 124 so as to input information. The inputted information is transmitted to the system controller 110. Further, the MFP 10 provides information to the operator via the operation/display unit 124 under the control of the system controller 110. A program controlling the operation of the MFP 10 is stored on a storage (RAM, ROM, HDD or the like not shown in the FIG. 2) in the system controller 110, and is executed by the CPU (also not shown in the FIG. 2) in the system controller 110.

In general, in addition to the scanning function, the MFP 10 has a copying function, a printing function, a facsimile transmission function and the like. The MFP 10 of the present invention is also capable of performing such functions, but the functions other than the scanning function have little relationship with the present invention, so configuration blocks for such functions are not shown and explanation is also omitted.

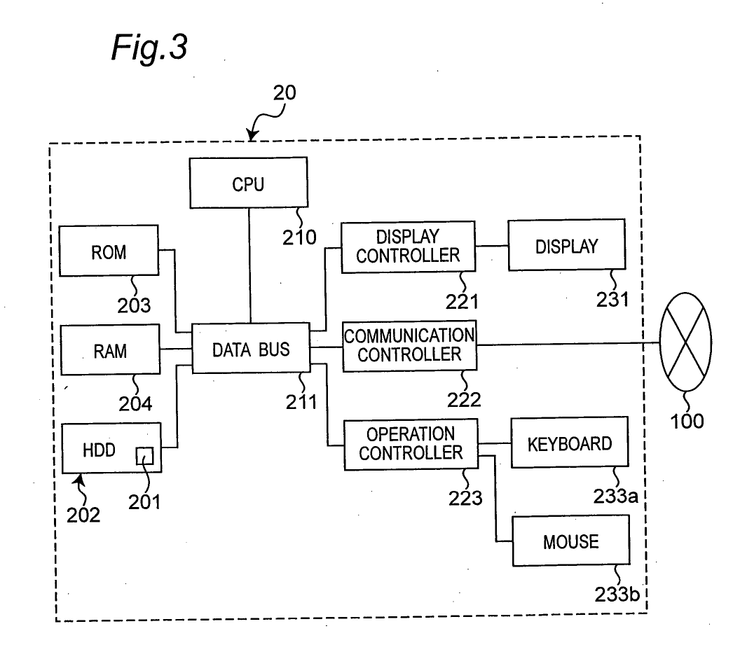

Next, the configuration of the client PC 20 will be described with reference to FIG. 3. The client PC 20 includes a central processing unit (CPU) 210. The CPU 210 is connected with a read-only memory (ROM) 203 and random access memory (RAM) 204 which are main storages and a hard disk drive 202 which is an auxiliary storage, via a data bus 211. The hard disk drive 202 can have a storage area for a shared folder 202 therein. Further, the CPU 210 is connected with a display controller 221, a communication controller 222 and an operation controller 223, via the data bus 211. The display controller 221 is connected with a display 231, and the operation controller 223 is connected with a keyboard 233a and a mouse 233b which is a pointing device. The display 231, the keyboards 233a and the mouse 233b constitute interfaces between the operator and the client PC 20. The communication controller 222 has connection means with the network 100, and performs transmission/reception of information with external equipment over the network 100 under the control of the CPU 210.

Since the configuration of the scanner server 30 may be same as that of the client PC 20, explanation of the scanner server 30 is omitted.

The client PC 20 and the scanner server 30 store, in the respective storages, application programs required to perform the present system, and the respective CPUs are capable of executing the application programs.

(Overview of Image Link Object)

Prior to detailed explanation of a image reading method, an image link object will be explained in brief. The image link object is an object created within the client PC 20 by the operator. An image link object includes a plurality of data areas such as: a scanner setting information data area for recording information about settings of the scanner (color mode, output file format, image quality, resolution, original size, etc.); a scanner data area for recording information about the MFP used for scanning; and a storage destination information data area of image data for recording information about storage destination of an image data file obtained through scanning and the file name of the image data file. The scanner setting information data area is capable of incorporating a plurality of data areas such as an attribute information data area for recording information about attributes (hidden file, access limit, encryption, etc.) of an image data file, but the scanner setting information data area is only required to be associated with the plural pieces of such data. In some cases, the scanner setting information data area is capable of including a decryption key etc. information data area for recording information about a decryption key and the like.

When a created image link object is opened (e.g., double-clicked), an image data file stored based on the storage destination information can be read. That is, it is possible to set the image link object linked with the stored image data file.

Further, an image link object can be created at any hierarchy (level) of the storage within the client PC 20. If the shell of an operating system (OS) has a graphical user interface (GUI), the image link object is displayed as an icon with a prescribed design. The client PC 20 has an OS provided with a GUI, so the image link object is displayed as an icon with a prescribed design. In the present embodiment, the image link object is called “shortcut to a scanned document” after a shortcut icon provided in the Windows (registered trademark) manufactured by Microsoft. However, “shortcut icon” provided in the above-mentioned OS, Windows, and “shortcut to a scanned document” in the present invention is clearly different. The details will become clear in the following explanation.

(Image Reading Procedure)

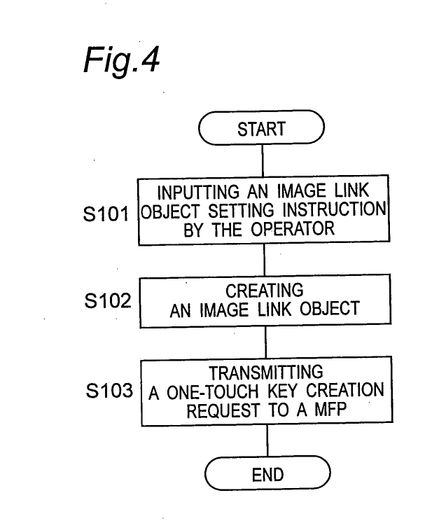

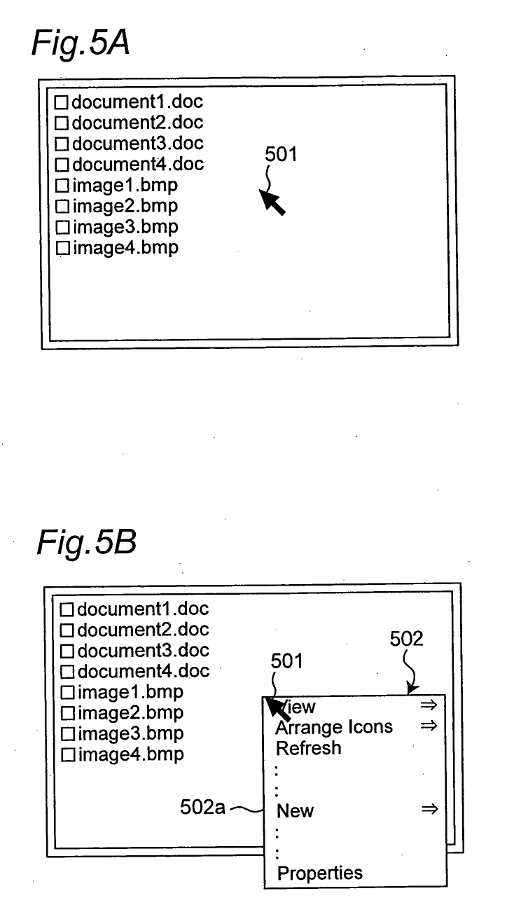

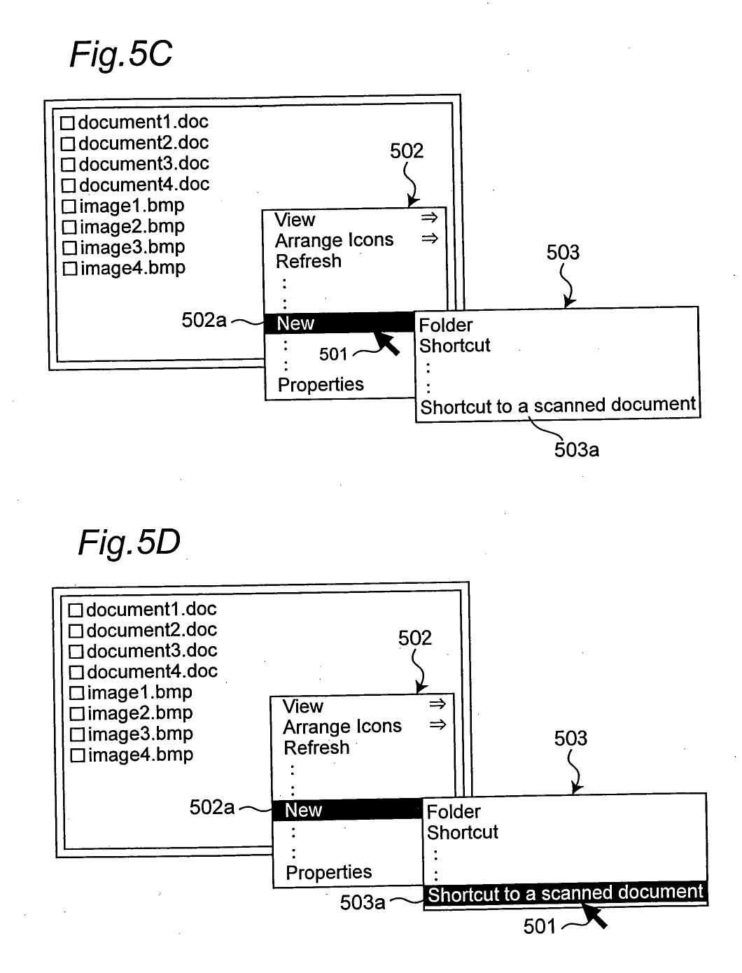

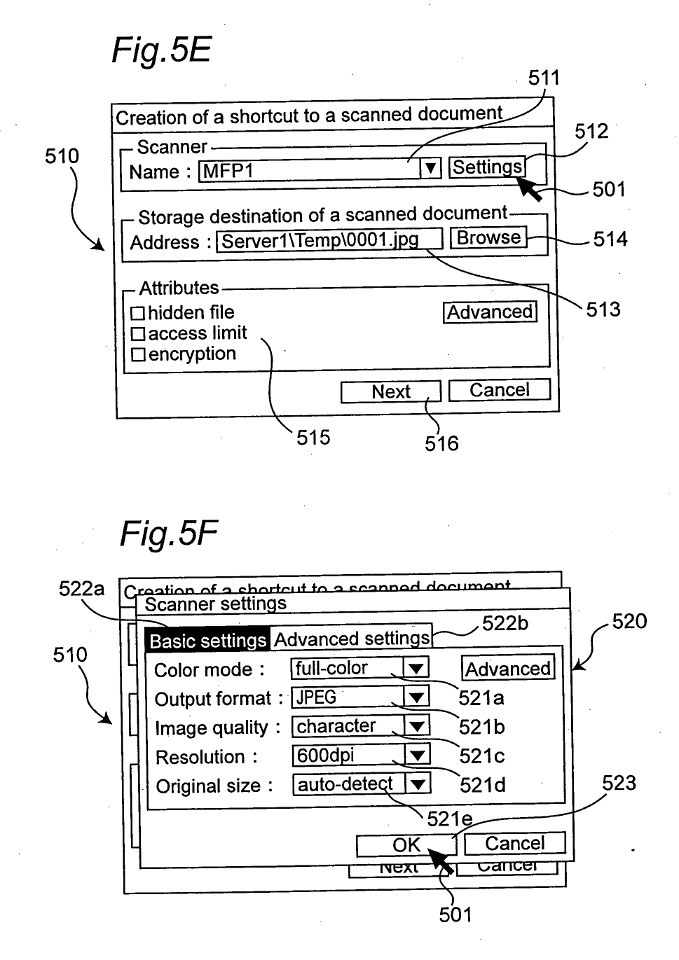

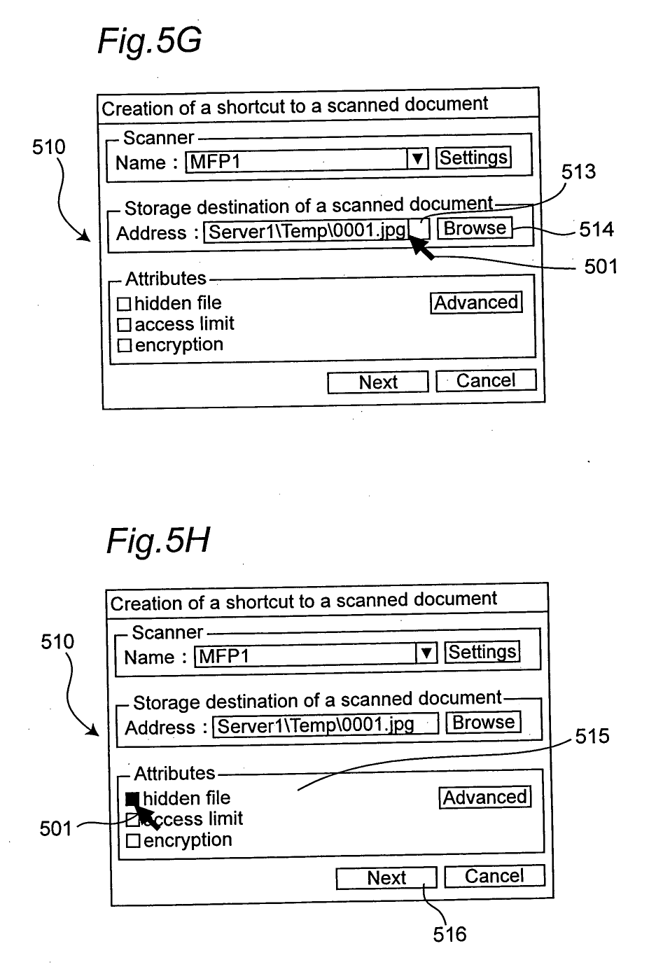

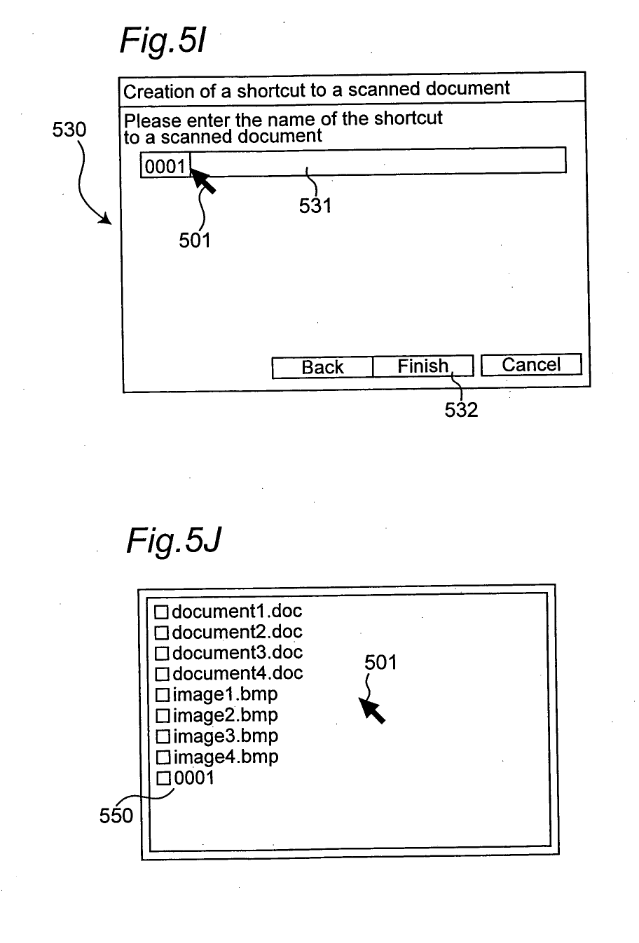

Hereinafter, an image reading method in an image reading system according to the present embodiment will be described with reference to flowcharts shown in FIGS. 4, 6 and 7 and FIGS. 5A, 5B, 5C, 5D, 5E, 5F, 5G, 5H, 5I, and 5J. FIG. 4 is a flowchart showing a part relating to an image link object creating process of a program which is stored on the storage 202, 203 or 204 of the client PC 20 and is installed so as to be executable by the CPU 210. Now, referring to FIG. 4 and FIGS. 5A, 5B, 5C, 5D, 5E, 5F, 5G, 5H, 5I, and 5J, a process from a creation of an image link object (shortcut to a scanned document) to a transmission of a one-touch key creation request to the MFP will be described.

First, an operator inputs an image link object setting instruction to the client PC 20 by using input devices such as the keyboard 233a and the mouse 233b (step (S101).

FIGS. 5A, 5B, 5C,and 5D are illustrations showing examples of the input of the image link object setting instruction performed by an operator. The operator displays a folder to which he/she desires to create an image link object in the display 231 of the client PC 20, and moves a mouse pointer 501 into a window showing the contents of the folder (FIG. 5A). In such a state, when the operator clicks the right button of the mouse for example, a context menu 502 is displayed (FIG. 5B). The operator points a menu “New” 502a in the displayed context menu. Then, objects which can be newly created are displayed in the sub menu 503 (FIG. 5C). The operator points “Shortcut to a scanned document” 503a in the sub menu 503, and clicks the left button of the mouse (FIG. 5D). Thereby, the client PC 20 accepts the image link object setting instruction performed by the operator (step S101).

Now, back to FIG. 4, the present program which accepted the image link object setting instruction creates an image link object (step S102). Here, prior to the creating step S102, in order to create an image link object, input of information for the image link object by the operator may be accepted. FIGS. 5E, 5F, 5G, 5H, and 5I are examples of information input windows. FIG. 5J is an illustration showing an exemplary display of the created image link object.

A first dialogue box 510 for “Creation of shortcut to a scanned document” is displayed on the display 231 (FIG. 5E). In the first dialogue box 510, selection of a scanner to be used, designation of a storage destination folder and a file name of image data obtained by the scanning (storage destination of the scanned document), and setting of the attributes of the image data file (hidden file, access limit, encryption, etc.) can be performed. Hereinafter, these settings will be described.

Devices currently capable of using the scanner function via the network 100 are displayed in the list box 511. A scanner to be used is selected by the operator from the list box 511. A Settings button 512 positioned on the right side of the list box 511 will be explained later with reference to FIG. 5F.

A storage destination folder and a file name of an image data file obtained through scanning (storage destination of the scanned document) are input from a text box 513 by the operator. Here, available storage destinations are shared folders (Boxes) 101, 201 and 301 existing within the network 100, and available file name to be input in the tail end portion of the text box 513 (in figure, “0001.jpg”) is an arbitrary character string. In order to simplify the input, a file name may be created automatically as a sequential number from the file name previously used (e.g., “0001.jpg”), or a date when the object is created may be input automatically as a file name (e.g., “20050401.jpg”) by using a internal clock of the client PC 20. An extension attached to the end of the file name may be input manually so as to designate the file format, but it may be added or changed automatically based on the setting of the output format described later. Although a storage destination is input in a text box format in this example, addresses of the shared folders (Boxes) 101, 201 and 301 within the network 100 may be selectable from a list box, and the input of the file name may be performed using a separate text box.

The attributes of an image data file are set by using a check box 515. Here, a hidden file means to give invisible attribute to an image data file obtained through scanning. The existence of the image data file to which invisible attribute is given is not displayed even if the shared folder in which the file is saved is displayed. Therefore, even when a third party views the shared folder in which the image data file is saved, it is difficult that the third party recognizes the existence of the image data file, so an improvement in security is expected. In this case, the substance of the image data file is also invisible to the operator, but the image data file can be read out without any problem by using an image link object as described later. Next, an access limit is a setting to authorize accesses to an image data file using an image link object and not to authorize other accesses, that is, accesses performed not using the image data object. Besides, it is also possible to give an access limit to an image data file by a user name logged in the network 100, and an access limit to an image data file by a client machine used for the access. An encryption attribute is an attribute to instruct the MFP 10 to encrypt the image data by using encryption and decryption algorithms.

Next, referring to FIG. 5F, setting of a scanner will be described. FIG. 5F illustrates an example of a “Scanner settings” dialogue box 520. The dialogue box 520 is displayed by pressing the Settings button 512 of the dialogue box 510.

The operator can display the “Scanner Settings” dialogue box 520 by pressing the Settings button 512 displayed on the upper right part of the first dialogue box 510 for “Creation of shortcut to a scanned document”. The dialogue box 520 has two panels, that is, a “Basic Settings” panel and an “Advanced Settings” panel (not shown). Display switching between the two panels can be performed by pointing a “Basic Settings” tab control 522a or a “Application Settings” tab control 522b with the mouse pointer 501, and clicking the mouse 233b. The “Basic Settings” panel displays current settings of the MFP 10 used for scanning, that is, a part of scanner setting information. The operator can change these settings 521a, 521b, 521c, 521d, and 521e displayed in the list box format by manipulating the mouse 233b. The basic settings include:

Color mode (can be set in multi-steps from full color to monochrome),

Output format (JPEG, TIFF, PDF, PNG, BMP, etc.),

Image quality (character, photograph, figure, etc.),

Resolution (can be set in multi-steps by dpi unit, etc.), and

Original size (including a manual setting of the original size in multi-steps by the operator and a setting for an automatic determination of the original size by the MFP 10) and the like. After changing and confirming the settings, the operator can validate the settings by manipulating (clicking) the OK button 523 with the mouse 233b.

FIG. 5G illustrates a method of input on “Scanned document storage destination”. The operator points inside a text box 513 with the mouse pointer 501 and clicks the mouse 233b whereby a cursor is displayed. In this state, the operator can input the storage destination of the scanned document from the keyboard 233a. When a “Browse” button 514 set on the right side of the text box 513 is clicked, the shared folders (Boxes) 101, 201 and 301 within the network 100, that is, shared storage areas, are displayed, so that the storage destination of the image data file can be selected easily by using the mouse or the like.

FIG. 5H illustrates a method of setting attributes of the image data file, that is, a method of inputting attribute information. The operator points each check box of a group of attribute check boxes 515 with a mouse pointer 501, and clicks the mouse 233b . For each attribute, valid and invalid is switched by each click. A valid attribute is checked, like a hidden file attribute. It is possible to perform detailed settings for each attribute by clicking a “Advanced” button placed on the right side of the group of check boxes 515. In the detailed (Advanced) settings, detailed access limit settings for the access limit attribute and detailed settings for encryption and decryption can be done, for example.

When input of information in the first dialogue box 510 is completed, the operator clicks a “Next” button 516 with the mouse 233b.

Then, the present program displays a second dialogue box 530 for “Creation of shortcut to a scanned document” (see FIG. 5I). The second dialogue box 530 has one text box 531. In the text box 531, the operator can input the name of an image link object (shortcut to the scanned document) itself. The inputting method may be same as the above-described method of inputting into the text box 513. Further, in order to reduce the workload of the operator, the name may be created automatically as a sequential number (e.g., “0002”) from the name of the image link object previously created (e.g., “0001”), and displayed on the text box 531 in advance. Alternatively, the name may be created automatically based on the current date by using an internal clock of the client PC 20 and displayed on the text box 531 in advance. Besides, the name of the object may be created automatically by combining the user name, the name of the client PC 20 in the network 100, or the like, and displayed. After g inputting the name of the object, the operator clicks an “Finish” button 532 with the mouse 233b.

By pressing the Finish button 532, the present program creates the image link object within a folder in a desired storage hierarchy of the client PC 20 (step S102). Further, it is possible to create the image link object in an arbitrary hierarchy of a storage which is provided outside the client PC 20 and is connected with the network 100 and is readable/writable by the client PC 20. FIG. 5J shows an example of displaying a folder in which the created image link object exists. An image link object named “0001” is displayed together with other files existing within the same folder.

Back to FIG. 4, next, a one-touch key creation request which includes information for requesting an execution preparation of scanning, that is, scan preparation information, including scanner setting information and storage destination information, is transmitted to the MFP 10 (step S103). If there are plural devices having scanning function connected with the network 100, the request is transmitted to a scanner to be used for scanning based on the information stored on or related to the scanner data area of the image link object. Further, it may be planned that the scan preparation information including scanner data is transmitted to all devices having the scanning function, and each of the devices received the information examines the scanner data and if the request is not related to oneself, the device disregards it. The one-touch key creation request may include, information indicating a request for one-touch key creation, and scanner data information designating a scanner to be used (e.g., MFP 10) set as described above, scanner setting information about the settings of the scanner to be used, information about a storage destination folder of the image data obtained through scanning and the file name of the image data (storage destination of the scanned document), that is, storage destination information, and information about attributes of the image data, that is, attribute information. Here, a one-touch key means a button provided on the operation/display unit 124 of the MFP 10 (FIG. 2) for instructing, by the operator, the start of scanning. The one-touch key may be different from a standard button provided constantly on the MFP 10 for instructing the start of scanning. Using the one-touch key set on the operation/display unit 124 of the MFP 10, the operator can instruct to start scanning according to the settings of the image link object with one operation. Thereby, the operator does not have to perform the setting of the scanner or the like by manipulating the operation/display unit 124 of the MFP 10 again and again. This leads to an improvement in operability. Since the MFP 10 of the present embodiment has a display panel, enabling a touch input, on the operation/display unit 124, the one-touch key is displayed in which a prescribed graphic and character information (the setting state of the scanner, some information about being created image data file such as a file name, the name of the image link object, etc.) are included, and the operator can start a scanning by touching the graphic. Although the scanning is started by pressing the one-touch key in the present embodiment, the pressing may only have the MFP 10 start reading out the scanner setting information and the storage destination information. In such a case, based on the read out information, the information is displayed on the operation/display unit 124. The actual start of the scanning may be performed with a standard button to start a scanning provided separately.

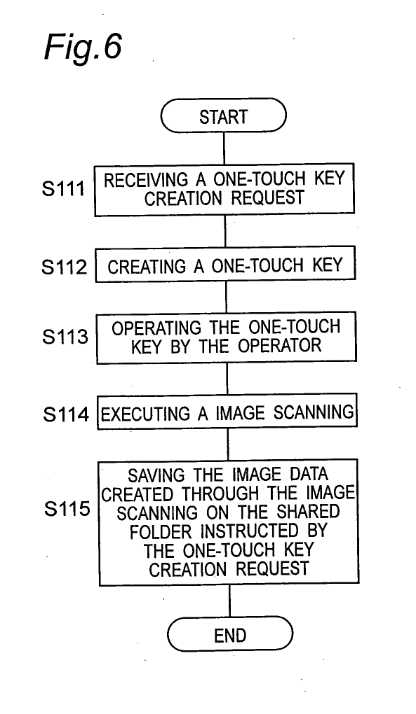

Note that there are some scanners which can start a scanning by receiving an instruction from the client PC 20. In such scanners, step S114 in FIG. 6, described later, may be executed immediately upon a reception of the creation request.

FIG. 6 is a flowchart showing a part of the process executable by the program, from the start of a scanning upon reception of the one-touch key creation request to the completion of the scanning. This program is stored on a storage (ROM, RAM, HDD, etc.), (not shown,) in the system controller 110 of the MFP 10 and is executable by the CPU, (not shown,) in the system controller 110. Hereinafter, a process of the MFP 10 after reception of the one-touch key creation request will be described with reference to FIG. 6.

First, the reception of the one-touch key creation request, which is input from the client PC 20 to the communication unit 123 over the network 100 is confirmed (step S111). Next, based on information contained in the one-touch key creation request, the one-touch key is created on the operation/display unit 124 (step S112).

The operator places an original to be scanned on the MFP10, and presses the one-touch key created on the operation/display unit 124. When the press of the one-touch key is confirmed (step S113), a scanning of the placed original is started based on the settings shown by the information included in the one-touch key creation request, that is, scanner setting information (step S114).

The scanned image data of the original is stored on the memory 102 temporarily. The data is converted to a data format instructed by the one-touch key creation request, and saved in a shared folder (Box) 101, 201 or 301 instructed by the storage destination information contained in the one-touch key creation request.

With the process described above, the image data of the original is saved in a desired shared folder in a storage hierarchy of storage.

The storage used for this saving is not necessarily storage within the client PC 20. Therefore, there is no need to share a part of the storage area of storage of the client PC 20 for transferring the image data file, so it is advantageous to the security.

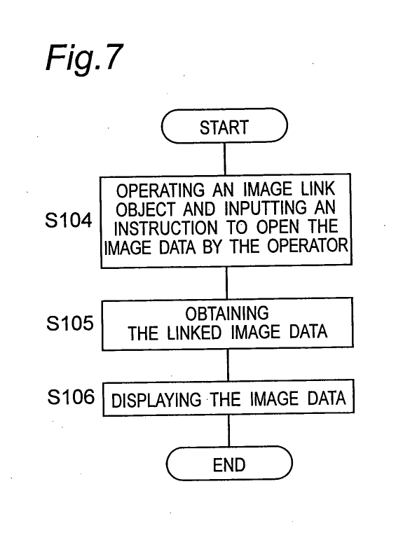

FIG. 7 is a flowchart showing a part of the process executable by the program according to the present invention. FIG. 7 shows a part of the process relating to a display of image data. This program is stored on storage 202, 203 or 204 of the client PC 20 and is installed so as to be executable by the CPU 210.

After the scanning is completed (step S115 is completed), the operator operates the client PC 20 so as to execute an operation to the image link object described later, thereby instructing the client PC 20 to display the image data which has been scanned. This instruction may be given by pointing an image link object 550 (FIG. 5J) displayed on the display 231 (FIG. 3) with the mouse pointer 501 and double-clicking the mouse 233b, for example. When the CPU 210 confirms that the instruction of displaying the image data is inputted (step S104), the CPU 210 obtains, over the network 100, an image data file (file shown by the information inputted in the storage destination text box 513 of the scanned document (see FIGS. 5E, 5G, etc.)) linked to the image link object based on information stored in or associated to the image link object, that is, storage destination information and the like (step S105). Then, the CPU 210 displays the obtained image data file on the display 231 (step S106). Further, the program may have a function of obtaining the linked image data file by, for example, right-clicking the image link object and saving it on the folder in which the image link object exists. At this time, it may be programmed that the image link object is deleted automatically when the saving of the image data file is completed. Further, the file name of the obtained image data file may be changed automatically to “name of the image link object”+“.”+extension (suitable for the file format) and saved.

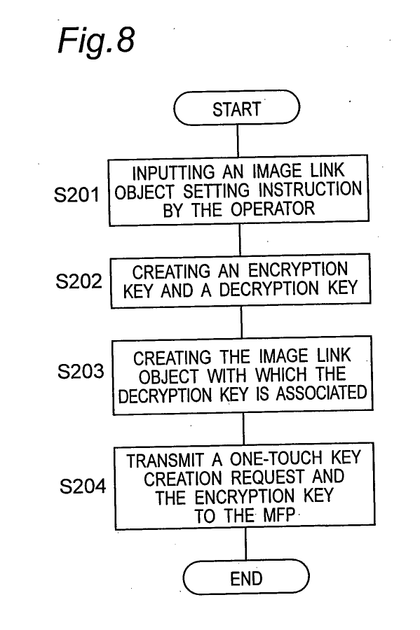

FIGS. 8, 9, and 10 are flowcharts of a program, executed by the CPU (not shown) in the system controller 110 of the MFP 10 and CPU 210 of the client PC 20 when the encryption attribute is given to a created image link object. Each flowchart of these shows a part relating to image link object creation processing (processing in which encryption processing is added to the processing shown in FIG. 4), a part relating to processing from reception of a one-touch key creation request to the start of scanning and to the completion of the scanning (processing in which encryption processing is added to the processing shown in FIG. 6), and a part relating to displaying of the image data (processing in which decryption processing of the encrypted image data is added to the processing shown in FIG. 7), respectively.

If the encryption attribute is validated in the setting of the image link object described above, the process shown in FIG. 8 is executed by the CPU 210 of the client PC 20. The process according to step S201 is same as that of step S101 (FIG. 4). Since the encryption attribute being validated by the operator in the setting of the image link object (see FIG. 5E, etc.), an encryption key and a decryption key are created prior to the creation of the image link object (step S202). The creation of an encryption key and a decryption key can be performed using a well-known asymmetric cryptographic algorithm. Alternatively, another cryptographic algorithm such as a common key system may be used. An image link object is created, in a data area of which the information about the decryption key of the created two keys is included (step S203). Alternatively, the information about the decryption key may be saved as a file separately and the image link object may store the information about the file, that is, be associated, instead of storing the information about the decryption key on the data area of the image link object. Then, information about the encryption key is included in the one-touch key creation request and transmitted to the MFP 10, or the information about the encryption key is transmitted to the MFP 10 together with the transmission of the one-touch key creation request (step S204).

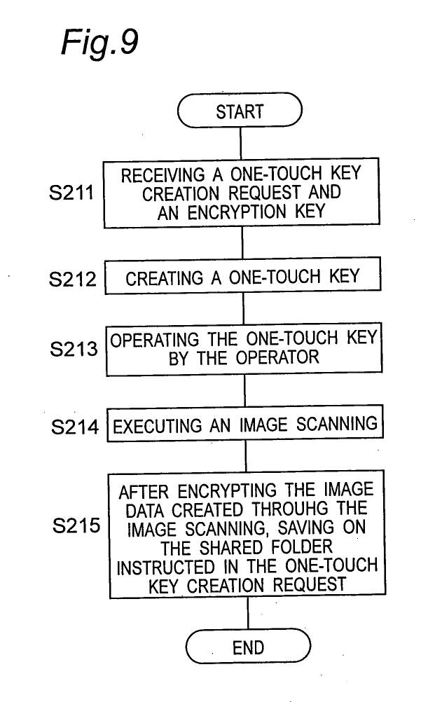

FIG. 9 is a flowchart showing a part of processing of a program from reception of the one-touch key creation request to the start of scanning and the completion of the scanning. This program is stored on storage (ROM, RAM, HDD, etc.) (, not shown,) in the system controller 110 of the MFP 10 and is executable by the CPU (, not shown,) in the system controller 110.

Step S211 is similar to the step S111 (FIG. 6). However, the received one-touch key creation request may include an encryption key, or one or more pieces of information about the encryption key may be received together with the reception of the one-touch key creation request. Next, a process from a creation of the one-touch key to an execution of scanning (steps S212 to S214) is performed in the same manner as steps S112 to S114 (FIG. 6)

After a conversion of the image data into a data having the data format instructed in the one-touch key creation request similar to step S115, the image data is encrypted based on the encryption key received together with the one-touch key creation request, if the information about the attributes of the image data, that is, attribute information, contained in the one-touch key creation request indicates that the encryption attribute is valid. And the encrypted image data file is saved on a shared folder (Box) 101, 201 or 301 instructed in the storage destination information included in the one-touch key creation request (S215).

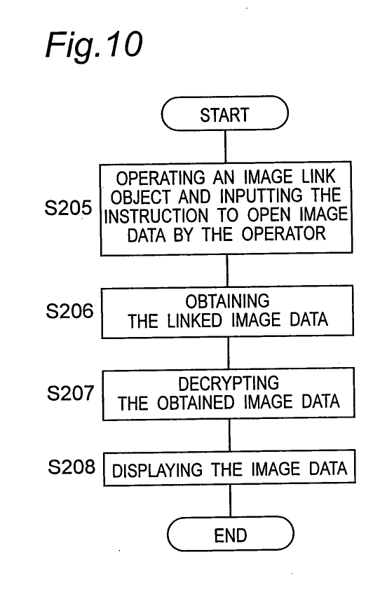

FIG. 10 is a flowchart showing a part of process of a program stored on storage 202, 203 or 204 of the client PC 20 and is installed so as to be executable by the CPU 210, relating to display of the encrypted image data file. Similar to steps S104 and S105, the image data is obtained by an instruction from the operator (steps S205 and S206). Next, in order to display the encrypted image data, the encrypted image data file is decrypted by using a decryption key included in the data area of the image link object or a file including the decryption key indicated by the information about the decryption key stored in the image link object (step S207). Then, the decrypted image data is displayed on the display 231 (step S208). Further, similar to the description relating to step S106 described above, there may be a function of saving the decrypted image data file in a folder in which the image link object exists after the image data file is obtained by right-clicking the image link object and decrypted, for example. In this case, it is possible to plan the program to delete the image link object automatically when saving of the image data file is completed. Further, the file name of the obtained image data file may be changed automatically to one like “name of the image link object+.+extension (suitable for the file format)” and then saved.

As described above, an image data file exists as an encrypted data file on the designated shared folder (Box) and the network 100. Therefore, it is advantageous from the security point of view.

(Procedure to Change the Image Link Object Settings)

It is expected that the settings of the created image link object may be required to be changed later. The settings of the image link object once created can be changed in the following manner.

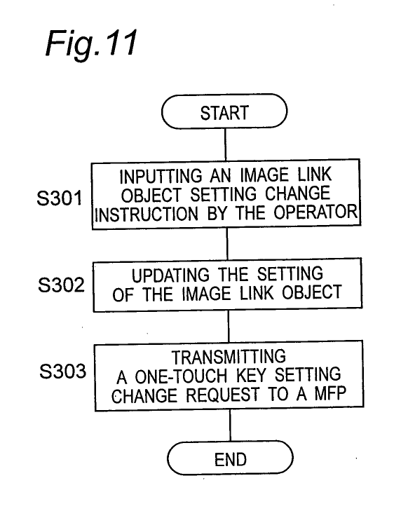

FIG. 11 is a flowchart of a part of process of a program stored on storage 202, 203 or 204 of the client PC 20 and is installed so as to be executable by the CPU 210. This process relates to the process to change the settings of the image link object.

An instruction to change the settings of the image link object is inputted by the operator (step S301). This instruction can be inputted by right-clicking the image link object 550 (FIG. 5J) so as to refer to the property of the object, for example.

When the change of settings is inputted, the settings of the image link object are changed in accordance with the contents of the change instruction (step S302) Then, a one-touch key setting change request is transmitted to the MFP 10 (step S303).

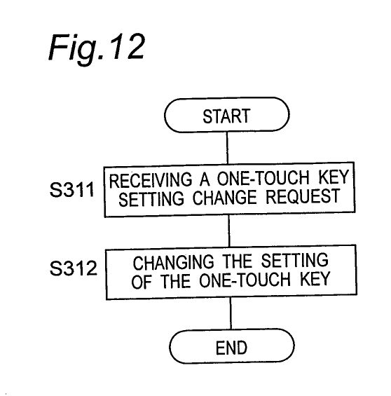

FIG. 12 is a flowchart showing a part of a program relating to processing from reception of a one-touch key setting change request to change of settings. This program is stored on a storage (ROM, RAM, HDD, etc.) (, not shown,) in the system controller 110 of the MFP 10 and is executable by the CPU (, not shown,) in the system controller 110.

The MFP 10 confirms a reception of the one-touch key setting change request (step S311). Next, based on the information of the one-touch key setting change request, the settings of the one-touch key currently set, that is, the settings of the scanner in scanning which is started by pressing the one-touch key and the settings relating to the storage destination of the data file to be created are changed.

Thereby, when it is desired to change the settings of the image link object after the image link object is created, it is possible to use the existing image link object without creating a new image link object. This improves the efficiency of the operation.

### Example of Modifications of the Present Embodiment

Instruction of image link object settings is not limited to a usage of a displayed context menu by right-clicking but may include a usage of a Task Panel that contains a command of the image link settings. The Task Panel is an available task list adopted in the Explorer of the Windows XP. Further, an image link setting command may be provided in pull-down menu of the folder.

An image reading apparatus is not limited to a digital complex machine (MFP) having a scanning function but may be a apparatus having a function of reading images and converting them into data suitable for processing by an information processing apparatus, such as a scanner.

The client PC 20 may be an information processing apparatus such as an electronic computer like a workstation, or a controller for image reading apparatus capable of operating an image reading apparatus and using shared resources within the network, besides a personal computer.

In the present specification, the term “original” is not limited to a paper media on which information is recorded by using ink or the like. The original includes information printed on a plastic film or the like, and a photographic film.

As this invention may be embodied in several forms without departing from the spirit of essential characteristic thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

What is claimed is:

1. An image reading system comprising:
an image reading apparatus which scans an original optically and converting the original to image data;
an information processing apparatus connected with the image reading apparatus over a network; and
a storage device having a shared storage area which is shared by the image reading apparatus and the information processing apparatus, the storage device is provided in the image reading apparatus or in the information processing apparatus or in another apparatus connected with the network, wherein
the information processing apparatus comprises:
an image link object creator which creates an image link object, where the image link object is associated with scanner setting information and storage destination information, where the scanner setting information is setting information relating to scanning of the image reading apparatus and the storage destination information is information about a storage destination of an image data file created by the scanning of the image reading apparatus; and
a transmitter which transmits scan preparation information to the image reading apparatus, where the scan preparation information includes the scanner setting information and the storage destination information, and
the image reading apparatus comprises:
a receiver which receives the scan preparation information transmitted from the information processing apparatus;
a scan executor which executes the scanning based on the scanner setting information; and
an image data saver which saves image data created through the scanning onto the storage destination of the image data file based on the storage destination information.

2. The image reading system as claimed in claim 1, wherein the information processing apparatus further comprises an information input/output controlling unit which displays a screen on a display unit of the information processing apparatus for inputting at least one of the scanner setting information and the storage destination information.

3. The image reading system as claimed in claim 1, wherein the image reading apparatus further comprises a button creator which creates a button with which an operator instructs the image reading apparatus to start the scanning based on the scan preparation information.

4. The image reading system as claimed in claim 1, wherein the scanner setting information associated with the image link object includes attribute information on the image data file.

5. The image reading system as claimed in claim 4, wherein the attribute information of the image data file includes at least one of an invisible attribute, an access limit attribute and an encryption attribute.

6. The image reading system as claimed in claim 5, wherein the access limit attribute is an attribute not to authorize an access to the image data file other than an access to the image data file via the image link object.

7. The image reading system as claimed in claim 5, wherein the encryption attribute is an attribute to request the image reading apparatus to encrypt the image data file and to save the encrypted image data file.

8. The image reading system as claimed in claim 1, wherein the information processing apparatus further comprises an information changer which changes at least one of the scanner setting information and the storage destination information associated with the image link object, and
the transmitter transmits contents of the change to the image reading apparatus.

9. An image reading method comprising the steps of:
creating an image link object on an information processing apparatus, where the image link object is associated with scanner setting information which is setting information relating to scanning of an image reading apparatus and with storage destination information which is information about a storage destination of image data created through the scanning by the image reading apparatus;
transmitting scan preparation information to the image reading apparatus from the information processing apparatus, where the scan preparation information includes the scanner setting information and the storage destination information associated with the image link object;
receiving the scan preparation information in the image reading apparatus;
executing the scanning based on the scanner setting information in the image reading apparatus; and
saving an image data file created in the scan executing step on the storage destination of the image data file based on the storage destination information.

10. The image reading method as claimed in claim 9, wherein the scan executing step includes the steps of:
creating a button with which an operator causes the image reading apparatus to start scanning based on the scan preparation information; and
pressing the button by the operator, wherein
the scanning is started after the press of the button.

11. A program, executable by an information processing apparatus, for prompting an image reading apparatus to execute scanning under a prescribed condition and to save an obtained image data file on a prescribed storage area, the program comprising the steps of:
creating an image link object which is associated with scanner setting information and storage destination information, where the scanner setting information is setting information relating to scanning of the image reading apparatus and the storage destination information is information about a storage destination of an image data file created by the scanning of the image reading apparatus; and
transmitting scan preparation information to the image reading apparatus, where the scan preparation information includes the scanner setting information and the storage destination information associated with the image link object.

12. A program, executable by an image reading apparatus, for performing scanning based on scan preparation information including scanner setting information which is setting information relating to scanning of the image reading apparatus and storage destination information which is information about a storage destination of an image data file created through scanning by the image reading apparatus, the program comprising the steps of:
receiving the scan preparation information transmitted by an information processing apparatus;
executing scanning based on the scanner setting information; and
saving an image data file obtained through scanning on the storage destination of the image data file based on the storage destination information.

13. The program executable by the image reading apparatus as claimed in claim 12, wherein the scan executing step includes the steps of:
providing a button for starting the scanning based on the scan preparation information; and
recognizing a press of the button performed by an operator, wherein
the scanning starts after the press.
